(19) United States
(12) Patent Application Publication
(10) Pub. No.: US 2026/0259030 A1
(43) Pub. Date: Sep. 3, 2026

(54) METHOD FOR MEASURING FLATNESS DEVIATIONS AND CURVATURE DIRECTIONS OF COMPONENTS IN A PUNCHING MACHINE

(71) Applicant: TRUMPF Werkzeugmaschinen SE + Co. KG, Ditzingen (DE)

(72) Inventors: Stephan Niessner, Illertissen (DE); Takeshi Abiko, Ditzingen (DE)

(21) Appl. No.: 19/657,032

(22) Filed: Apr. 24, 2026

Related U.S. Application Data
(63) Continuation of application No. PCT/EP2024/080447, filed on Oct. 28, 2024.

(30) Foreign Application Priority Data
Oct. 30, 2023 (DE) 10 2023 129 958.1

(51) Int. Cl. G01B 5/20; B21C 51/00; B21D 28/26

(52) U.S. Cl. CPC G01B 5/20; B21C 51/00; B21D 28/26

(57) ABSTRACT

A method for measuring flatness deviations and curvature directions of components in a punching machine including an upper tool and a lower tool forming a die including a central die part, the method including measuring a distance between an upper starting position of the upper tool and the die and placing a component to be measured onto the die. The upper tool is moved from the upper starting position until an increase in force being exerted on the upper tool indicates contact between the upper tool and the component, and a path of the upper tool until it contacts the component is measured. The distance of the upper tool to the die and the path traversed by the upper tool until contacting the component with a starting thickness of the component are compared and whether the central die part has moved downwards or remains in its starting position is checked.

### CROSS REFERENCE TO RELATED APPLICATIONS

This application is a continuation of International Application No. PCT/EP2024/080447 (WO 2025/093490A1), filed on Oct. 28, 2024, and claims benefit to German Patent Application No. DE 10 2023 129 958.1, filed on Oct. 30, 2023. The aforementioned applications are hereby incorporated by reference herein.

### FIELD

The invention relates to a method for measuring flatness deviations and curvature directions of components in a punching machine, a measuring system for carrying out such measurements, and a punching machine comprising such a measuring system.

### BACKGROUND

When punching sheet metal parts, in particular thinner sheet metal parts, undesirable curvatures of the sheet metal part can occur. This risk increases with the level of wear of the punching tools. The components of a punching machine are therefore subjected to quality control checks following the punching process, but these checks takes place externally to the machine. In addition to determining the size of the flatness deviations of the components, the direction of curvature must also be determined in order to readjust the process parameters of the machine to avoid further defective components. In addition to the magnitude of the flatness deviation, determining the direction of curvature is also important for any potential post-processing of the components. In order to determine these dimensions on the finished components, cameras or optical and/or tactile sensors are used in the known methods.

However, due to downstream quality control, adjustments to the machine's process parameters cannot be made in a timely manner, meaning that a relatively large number of parts have to be sorted out as rejects or undergo post-processing. Any subsequent post-processing of components may also be delayed.

### SUMMARY

In an embodiment, the present disclosure provides a method for measuring flatness deviations and curvature directions of components in a punching machine comprising an upper measuring tool and a lower measuring tool in the form of a die comprising a central die part which can be moved downwards, the method comprising measuring a distance between an upper starting position of the upper measuring tool and the die and placing a component to be measured onto the die. The method further comprises moving the upper measuring tool from the upper starting position thereof until an increase in the force being exerted on the upper measuring tool indicates a contact between the upper measuring tool and the component, and measuring a path of the upper measuring tool up until it contacts the component. The method further comprises comparing the distance of the upper measuring tool to the die and the path traversed by the upper measuring tool up until contacting the component with a starting thickness of the component and checking whether the central die part has moved downwards or remains in its starting position.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a and FIG. 1b show a schematic representation of a starting phase of a method according to an embodiment of the present disclosure and an associated force-path diagram and a level-path diagram;

FIG. 2a and FIG. 2b show a schematic representation of a reference measurement according to the method according to an embodiment of the present disclosure and an associated force-path diagram and a level-path diagram;

FIG. 3a and FIG. 3b show a schematic representation of a first phase of a measurement of a convex curved component and an associated force-path diagram and a level-path diagram;

FIG. 4a and FIG. 4b show a schematic representation of a final phase of the measurement of a convex curved component and an associated force-path diagram and a level-path diagram;

FIG. 5a and FIG. 5b show a schematic representation of the final phase of a measurement of a concave curved component and an associated force-path diagram and a level-path diagram;

FIG. 6 shows an enlarged view of the measurement of the convex component according to FIG. 4a; and

FIG. 7 shows an enlarged detailed view of a lower measuring tool from FIG. 6.

### DETAILED DESCRIPTION

In an embodiment, the present disclosure provides for the measurement of flatness deviations and curvature directions of components directly in the punching machine.

The foregoing is achieved according to the present disclosure by a method for measuring flatness deviations and curvature directions of components in a punching machine, comprising an upper measuring tool and a lower measuring tool in the form of a die comprising a central die part which can be moved downwards, having the steps of:
measuring the distance between an upper starting position of the upper measuring tool and the die;
placing a component to be measured onto the die;
moving the upper measuring tool from the upper starting position thereof until an increase in the force being exerted on the upper measuring tool indicates a contact between the upper measuring tool and the component, and measuring the path of the upper measuring tool up until it contacts the component; and
comparing the distance of the upper measuring tool to the die and the path traversed by the upper measuring tool up until contacting the component with a starting thickness of the component and checking whether the central die part has moved downwards or remains in its starting position.

The term “flatness deviation” is defined herein as the smallest distance between two ideal planes, wherein all points of the measured component surfaces must lie between these two planes. For a completely flat component, the flatness deviation is therefore zero. The starting thickness d of the component is its thickness before the punching process, i.e., usually the thickness of the sheet metal used as the blank for the punching process.

The magnitude of a flatness deviation of the component can be determined by comparing the starting thickness of the component with the difference between the distance traversed by the upper measuring tool until it impacts on the component and the distance between the upper starting position of the upper measuring tool and the die.

Checking whether the central die part is pressed downwards by the component during measurement allows a statement to be made about the curvature direction of the component. A convex curved component can be identified if movement of the central part of the die is detected. In contrast, a concave curved component can be concluded if the difference between the measured path of the upper measuring tool up until contacting the component and the distance between the upper starting position of the upper measuring tool and the die is greater than the starting thickness of the component and the central part of the die remains in its rest position.

Measuring the distance between the upper starting position of the upper measuring tool and the plane of the lower measuring tool can be absolute, i.e., an absolute value for this distance can be determined. Alternatively, the position of the upper and lower measuring tools can be referenced. In order to measure the distance between the upper starting position of the upper measuring tool and the plane of the lower measuring tool, the upper measuring tool can be moved from its upper starting position onto the lower measuring tool until an increase in the force being exerted on the upper measuring tool indicates that the upper measuring tool is impacting on the lower measuring tool, and the path traversed by the upper measuring tool up until contacting the lower measuring tool is measured. This path corresponds to the distance between the upper starting position of the upper tool and the lower tool and is stored.

The magnitude of the flatness deviation of the component can be calculated from the formula h=s₀−s₁−d, wherein s₀ is the distance between the upper starting position of the upper measuring tool, s₁ is the path of the upper tool from its upper starting position up until contacting the component and d is the starting thickness of the component.

The signals from the force sensor, the path measuring device and the central die part can preferably be synchronized in a timely manner in order to quickly obtain a measurement result for the component.

If concave or convex curved components are identified, post-processing of these components can be carried out in the punching machine if the flatness deviation exceeds a predefinable tolerance value. In this way, parts that were only identified as defective in a quality control process external to the punching machine using known methods can undergo post-processing promptly and without manual intervention. This allows the number of rejected parts to be cost-effectively reduced.

Furthermore, if a convex or concave curved component is identified, and if the flatness deviation exceeds a predefinable tolerance value, process parameters of the punching machine can be adjusted in such a way that curvature of the components is avoided in the production of future components.

There are various ways to determine the position of the central die part. In an embodiment, when measuring a convex curved component, the central die part can be moved downwards by the component against a back pressure generated in the die, thereby opening a back pressure valve integrated in the die, the opening of which is monitored as an indicator of a convex curved component. A change in the back pressure can preferably be monitored as an indicator of the opening of the back pressure valve. A sudden drop in pressure indicates that the valve has opened.

Alternatively, the position of the back pressure valve itself can be monitored. For example, the opening of an electrical contact can indicate that the valve has opened.

For precise measurement of the flatness deviation and the curvature direction of the components, a punch-shaped tool with a flat surface on its underside can preferably be used as the upper measuring tool. In this case, the surface of the die and the surface on the underside of the upper measuring tool are exactly parallel.

The upper and lower measuring tools can be inserted in the machine by a tool changer before the measurement takes place, so that quality control can be carried out immediately after the punching process.

In an embodiment, the present disclosure provides a measuring system for carrying out a method according to the present disclosure, comprising an upper measuring tool and a lower measuring tool in the form of a die having a central part that can be moved downwards, characterized in that it comprises a path measuring device for measuring the movement of the upper measuring tool, a measuring device for measuring the force exerted on the upper measuring tool, a monitoring device for monitoring the movement of the central die part, and an evaluation device for synchronizing the signals of the force measuring device, the path measuring device, and the monitoring device of the central die part.

In an embodiment, the present disclosure provides a punching machine having such a measuring system, wherein the punching machine is also designed to carry out a method according to the present disclosure. The evaluation unit of the measuring system can preferably be connected to the control device of the punching machine.

Further features and advantages of the present disclosure can be found in the description and the drawings. According to the present disclosure, the features mentioned above and those yet to be explained further can be used in each case individually or together in any desired expedient combination. The embodiments shown and described should not be understood as an exhaustive enumeration, but rather are of an exemplary character.

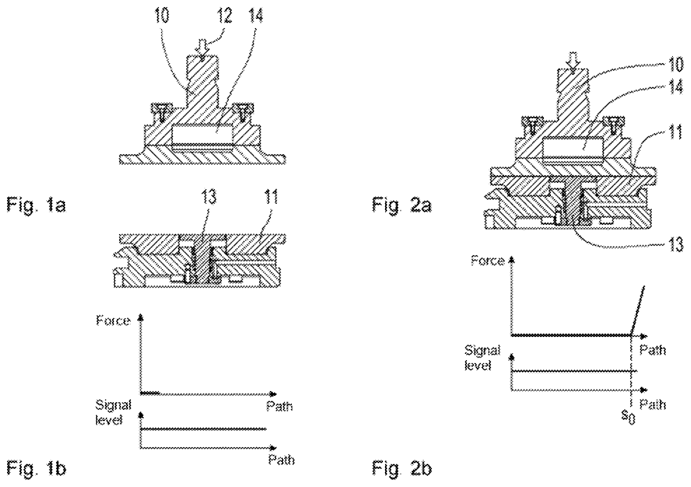

FIG. 1a shows a schematic representation of an upper measuring tool 10 and a lower measuring tool 11 of a punching machine. The upper measuring tool 10 is shown in its upper starting position. It can be moved by exerting a force 12 in the direction of the lower measuring tool 11. The path traversed by the upper measuring tool 10 is recorded by a path measuring system. In the illustrated embodiment, a force sensor 14 is also integrated into the upper measuring tool 10. However, the measurement of the force exerted on the upper measuring tool 10 can also be carried out in a drive unit of the machine. The lower measuring tool 11 is a die with a central part 13 that can be moved downwards. The signals from the force sensor 14 and the path measuring system are synchronized and the force-path diagram shown in FIG. 1b illustrates this. In this starting phase of the method, the diagram shows a path and force of zero. Furthermore, the position of the central die part 13 is recorded in a level-path diagram. The signal level in FIG. 1b is high over the entire path length of the upper measuring tool 10 and thus indicates a position of the central die part 13 in its upper starting position.

FIG. 2a shows a reference measurement being carried out. The upper measuring tool 10 has been moved downwards until it contacts the lower measuring tool 11. The associated force-path diagram in FIG. 2b shows a strong increase in the force measured by the force sensor 14 after the upper measuring tool 10 traversed a path s₀. The path s₀ is the path traversed by the upper measuring tool 10 until it contacts the lower measuring tool 11 and thus corresponds to the distance between the upper starting position of the upper measuring tool 10 and the lower measuring tool 11. The value s₀ is stored as a reference value. The signal level of the central die part 13 remains high during the reference measurement because its position does not change.

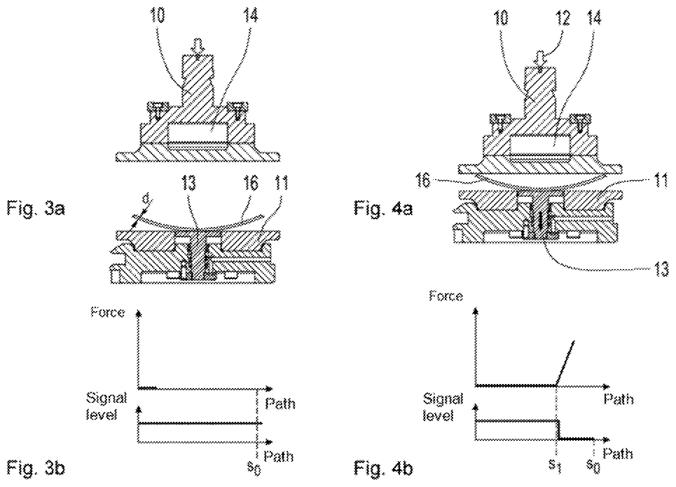

The upper measuring tool 10 is then moved back to its upper starting position and a component 16—here a convex curved sheet metal part—is placed on the die 11, as can be clearly seen in FIG. 3a. The associated force-path diagram in FIG. 3b continues to show a path and force of zero, and the signal level of the central die part 13 is high.

In order to measure the flatness deviation h of the curved component 16 and its curvature direction, according to FIG. 4a, by exerting a force 12, the upper measuring tool 10 is moved downwards from its upper starting position up until it contacts the component 16. The associated force-path diagram in FIG. 4b shows a sharp increase in the force measured by the force sensor 14 as soon as the upper measuring tool has traversed a path s₁ up until it contacts the component 16. The force-path diagram in FIG. 4b also shows the reference value s₀. The flatness deviation can then be calculated from the two variables s₀ and s₁ according to the formula

$$h = {s}_{0} - {s}_{1} - d$$

wherein d is the starting thickness of the component 16, which is already known before the component is produced.

Since the component 16 is convex curved, it also pushes the central die part 13 downwards as soon as it is contacted and pushed downwards by the upper measuring tool 10. The level-path diagram in FIG. 4b therefore shows an abrupt drop in the level after the path length s₁ traversed by the upper measuring tool 10. From this drop in level, it can therefore be concluded that the component 16 is concave curved, while the flatness deviation h indicates the magnitude of curvature.

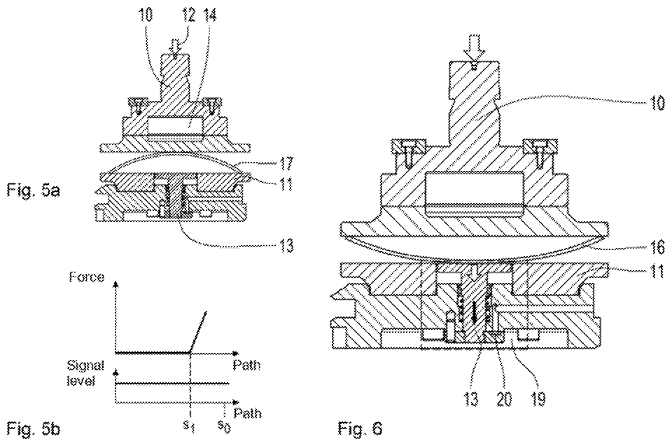

In contrast, FIG. 5a shows the measurement of the flatness deviation and curvature direction of a concave component 17. The upper measuring tool 10 has been moved downwards by the force 12 until it contacts the component 17. The upper measuring tool has traversed the path s₁. As soon as the measuring tool 10 contacts the component 17, there is a sharp increase in the force measured by the force sensor 14, as shown in the force-path diagram in FIG. 5b. The central die part 13, however, is not contacted by the component 17 due to its concave curvature. The signal level of the position measurement of the central die part 13 therefore remains high and unchanged over the entire path length of the upper measuring tool 10. The flatness deviation can also be calculated for concave components 17 according to the formula h=s₀−s₁−d. The unchanged high signal level of the central die part 13 shows that the flatness deviation h originates from a concave and not a convex curvature of the component 17.

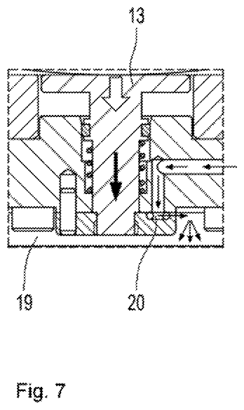

The enlarged illustrations of FIG. 6 and FIG. 7 show the structure of the die 11 comprising the central die part 13 and the processes occurring during the measurement of a convex curved component 16. The central die part 13 can be moved downwards in the direction of the arrow. This movement is counteracted by a back pressure (negative pressure) built up in a chamber 19 in the die 11. The chamber 19 is sealed off from the ambient air by a valve 20. If the central die part 13 moves downwards due to the pressure exerted by the convex component 16, the valve 20 opens. This leads to a drop in back pressure, the measurement of which can therefore indicate whether the measured component 16 is a convex curved component or a flat or concave curved component. The level-path diagrams shown in FIGS. 1b, 2b, 3b, 4b and 5b are pressure levels measured in the chamber 19. Of course, the position of the central die part 13 can also be achieved by other means.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for measuring flatness deviations and curvature directions of components in a punching machine comprising an upper measuring tool and a lower measuring tool in a form of a die comprising a central die part which can be moved downwards, the method comprising:
measuring a distance between an upper starting position of the upper measuring tool and the die;
placing a component to be measured onto the die;
moving the upper measuring tool from the upper starting position thereof until an increase in a force being exerted on the upper measuring tool indicates a contact between the upper measuring tool and the component, and measuring a path of the upper measuring tool up until it contacts the component;
comparing the distance of the upper measuring tool to the die and the path traversed by the upper measuring tool up until contacting the component with a starting thickness of the component and checking whether the central die part has moved downwards or remains in its starting position.

2. The method according to claim 1, wherein a concave curved component is identified when a movement of the central part of the die is detected.

3. The method according to claim 1, wherein a convex curved component is identified when the difference between the measured path of the upper measuring tool up until contacting the component and the distance between the upper starting position of the upper measuring tool and the die is greater than the starting thickness of the component and the central part of the die remains in its rest position.

4. The method according to claim 1, wherein, in order to measure the distance between the upper starting position of the upper measuring tool and the plane of the die, the upper measuring tool is moved from its upper starting position onto the die until an increase in the force being exerted on the upper measuring tool indicates that the upper measuring tool is impacting on the die and the path traversed from the upper measuring tool up until contacting the die is measured.

5. The method according to claim 1, wherein the magnitude of the flatness deviation of the component is calculated from the formula h=s₀−s₁−d, wherein s₀ is the distance between the upper starting position of the upper measuring tool and the die, s₁ is the path of the upper tool from its upper starting position up until contacting the component and d is the starting thickness of the component.

6. The method according to claim 1, wherein, if concave or convex curved components are identified, post-processing of the component is carried out in the punching machine if the flatness deviation exceeds a predefinable tolerance value.

7. The method according to claim 1, wherein, if a convex or concave curved component is identified, and if the flatness deviation exceeds a predefinable tolerance value, process parameters of the punching machine are adjusted such that curvature of the components is avoided in production of future components.

8. The method according to claim 1, wherein, when measuring a convex curved component, the central die part is moved downwards by the component against a back pressure generated in the die, thereby opening a back pressure valve integrated in the die, the opening of which is monitored as an indicator of a concave curved component.

9. The method according to claim 8, wherein a change in the back pressure is monitored as an indicator of an opening of the back pressure valve.

10. The method according to claim 8, wherein a position of the back pressure valve is monitored.

11. The method according to claim 1, wherein a punch-shaped tool with a flat surface on its underside is used as the upper measuring tool.

12. The method according to claim 1, wherein the upper and lower measuring tools are inserted in the machine by a tool changer before the measurement takes place.

13. A measuring system for carrying out the method according to claim 1, comprising:
the upper measuring tool;
the lower measuring tool in the form of the die having the central part that can be moved downwards;
a path measuring device for measuring the movement of the upper measuring tool;
a measuring device for measuring the force exerted on the upper measuring tool,
a monitoring device for monitoring the movement of the central die part; and
an evaluation device for synchronizing the signals of the force measuring device, the path measuring device and the monitoring device of the central die part.

14. A punching machine comprising the measuring system according to claim 13.
